(19) United States
(12) Patent Application Publication
(10) Pub. No.: US 2024/0055699 A1
(43) Pub. Date: Feb. 15, 2024

(54) Thermally Robust Cell Assembly, and Cell Module Comprising Such a Cell Assembly

(71) Applicant: Bayerische Motoren Werke Aktiengesellschaft, Muenchen (DE)

(72) Inventors: Andreas KLAFFKI, Unterschleissheim (DE); Christoph KLAUS, Oberschleissheim (DE); Christian LINSE, Muenchen (DE); Philipp SCHMIDT, Muenchen (DE); Sophie SOLCHENBACH, Muenchen (DE)

(21) Appl. No.: 18/267,139

(22) PCT Filed: Nov. 5, 2021
(86) PCT No.: PCT/EP2021/080789

§ 371 Date: Jun. 14, 2023

(30) Foreign Application Priority Data
Dec. 15, 2020 (DE) 10 2020 133 450.8

(51) Int. Cl. H01M 10/658; H01M 50/293; H01M 10/653; H01M 50/209; H01M 10/04; H01M 10/647

(52) U.S. Cl. CPC H01M 10/658; H01M 50/293; H01M 10/653; H01M 50/209; H01M 10/0481; H01M 10/647

(57) ABSTRACT

A cell assembly for an electrochemical energy storage device has: two cells for electrochemically storing electric energy; and a first insulating body for thermally insulating the two cells from each other. The insulating body is arranged between the cells in an intermediate space delimited by a respective lateral surface of each of the two cells and is configured to absorb pressure exerted by the lateral surfaces of the two cells on lateral surfaces of the first insulation body, where compression occurs along a compression direction. The insulating body includes a first thermally insulating and compressible fiber material and has a rigidity as a function of compression, where a value curve of the rigidity has a first compression value section and a second compression value section adjoining the first compression value section. A cell module has a cell assembly and a high-voltage storage device has a cell module as described herein.

### BACKGROUND AND SUMMARY

The present invention relates to a cell assembly of two or more cells for storing electrical energy, a cell module comprising such a cell assembly, and a high-voltage storage device which contains this cell module.

FIG. 1 shows a cell module 100, which includes multiple battery cells 101 arranged in a series. In this series, two adjacent battery cells 101 are each separated from one another by a PET plastic film 102 and two compressible spacers 103. The PET plastic film 102 is provided on one of the two opposite lateral surfaces of two adjacent battery cells 101 and the two spacers are adhesively bonded on the respective PET plastic film 102. The lateral surfaces of the battery cells 101 are thus electrically insulated from one another and a space results adjacent to each battery cell 101, into which the battery cell 101 can bulge during the charging/discharging cycles. The series of the battery cells is terminated at both ends by a pressure plate 115 in each case and is held together using a frame (not shown in the figure). During the production of the cell module 100, the spacers 103 are adhesively bonded on the respective PET plastic film 102; the battery cells 101 are arranged in series in such a way that each two adjacent cells are separated by the PET plastic film 102 and the spacers 103; the ends of the series are each terminated using a pressure plate 115; the series thus formed is compressed to a specified length; and the series compressed to the specified length is provided with a frame, which holds together the series. Possible tolerance variations of the battery cells 101 can be equalized, upon the compression of the battery cells arranged in series, by the compressible spacers. The PET plastic film 102 can have a thickness of 0.1 mm and the spacers 103 can each have a thickness of 1 mm.

On the one hand, tolerance variations of the battery cells 101 upon compression are equalized and, on the other hand, the bulging of the battery cells 101 during the charging/discharging cycles is enabled by the use of compressible spacers 103 in the cell module 100. The air contained in the intermediate space delimited by two opposing lateral surfaces offers a certain thermal insulation between two adjacent cells, in order, in case of a thermal runaway of a cell, to slow the spreading of the thermal runaway to adjacent cells and thus a thermal runaway of the entire cell module 100. However, the cells bulge out more and more with progressing age and the distance between two opposing lateral surfaces of the cells (cell bulges) decreases, which reduces the air gap and the corresponding thermal insulation of adjacent cells.

It is therefore an object of the present disclosure to provide a thermally robust cell assembly and a cell module for a high-voltage storage device having high energy density, in which the heat conduction between adjacent cells, even at advanced age of the cells, is reduced enough that a thermal runaway can be delayed or prevented.

This object may be achieved according to the teaching of the independent claims. Various embodiments and refinements of the invention are the subject matter of the dependent claims.

A first aspect of the present disclosure relates to a cell assembly for an electrochemical energy storage device, including: two cells for electrochemically storing electrical energy; and a first insulation body for thermally insulating the two cells from one another. The first insulation body is arranged in an intermediate space between the two cells delimited by one lateral surface of each of the two cells, and is configured to absorb a pressure exerted by the lateral surfaces of the two cells on lateral surfaces of the first insulation body respectively opposite thereto, where the compression is along a compression direction. The first insulation body comprises a thermally insulating and compressible material and has a rigidity as a function of the compression, where a value curve of as the rigidity includes a first compression value section and a following second compression value section adjoining the first compression value section. A slope of the rigidity as a function of the compression in the second compression value section is higher than a maximum slope of the rigidity as a function of the compression in the first compression value section. The rigidity at a specific compression value within the second compression value section has a value at least two times as high as a maximum rigidity in the first compression value section. The specific compression value corresponds to a thickness of the first insulation body along the compression direction at which the insulation body has a specific heat resistance of at least 5 m·K/W along the compression direction. The specific thermal resistance of 5 m·K/W may correspond to a thermal conductivity of 0.2 W/mK.

The spreading of a thermal runaway from one cell to another can thus be delayed or even prevented.

In the meaning of the present disclosure, rigidity is a characteristic representing resistance that may be provided by a body (for example an insulation body) against a deformation by external action (for example an external force acting on the body). For example, during the pressing of the cell assembly and its connecting/fixing to form a cell module, a pressure acts on the insulation body that presses together (compresses) the insulation body and which this insulation body absorbs due to its rigidity without being compressed enough that its thickness falls below a minimum thickness in the compression direction. In addition to the force occurring due to the fixing of the cell assembly to form a cell module, a pressure can also act on the insulation body that is caused by the bulging of the cells. In this case, the insulation body has a rigidity which enables it to absorb the pressure caused by the fixing and also the pressure caused by the bulging.

If the deformation of the body occurring due to the external action is elastic, the following applies with free cross concentration of the cross-section:

S=E·A,

wherein S is the rigidity (axial rigidity) of the body, E is its modulus of elasticity in the load direction, and A is its area perpendicular to the load direction.

In the meaning of the present disclosure, the compression of a body is to be understood as the ratio |ΔL|/L₀, wherein ΔL is the length change of the body which it experiences under the external action, and L₀ is the length of the body before the occurrence of the external action. In the case of elastic deformation, the following applies:

ΔL/L₀=F/S=(p·A)/(E·A)=p/E,

wherein F is the force acting on the area A of the body and p=F/A is the pressure on the body in the load direction.

In the meaning of the present disclosure, the specific heat resistance is to be understood as the reciprocal of the thermal conductivity. Its unit is: (mK)/W (meters times kelvins divided by watts). The thermal conductivity of an insulation body which includes a compressible material can increase with increasing compression of the material. In particular in the case of a fiber material, the contact points between fibers can increase due to the compression of the fiber material and the intermediate spaces between the fibers can decrease.

In the meaning of the present disclosure, the area weight of a fiber material is to be understood as the weight of the fiber material which is contained in an insulation body that has a size of 1 m². An insulation body can contain fillers in addition to the fiber material, which are arranged in the intermediate spaces formed by the fibers of the fiber material.

The terms “comprises”, “contains”, “incorporates”, “includes”, “has”, “with”, or any other variant thereof used here are to cover a nonexclusive incorporation. Thus, for example, a method or a device which comprises or includes a list of elements is not necessarily restricted to these elements, but rather can incorporate other elements, which are not expressly listed or which are inherent to such a device or such a method.

Furthermore, “or”, if the contrary is not expressly specified, relates to an inclusive or and not to an exclusive “or”. For example, a condition A or B is met by one of the following conditions: A is true (or present) and B is false (or not present), A is false (or not present) and B is true (or present), and both A and B are true (or present).

The terms “a”, “an” or “one”, as used here, are defined in the meaning of “one or more”. The terms “another” and “a further” and any other variant thereof are to be understood in the meaning of “at least one further”.

Preferred embodiments of the cell assembly according to the invention and its refinements are described hereinafter, which, if not expressly precluded or technically impossible, can be combined as desired with one another and with the further described other aspects of the invention.

In one preferred embodiment, the specific compression value corresponds to a pressure on the opposing lateral surfaces of the first insulation body along the compression direction of at least 1 MPa.

The first insulation body can thus absorb both the pressure which may be required for fixing the cell assembly (in a cell assembly) and the pressure which may arise due to the bulging of the cells at advanced age of the cells, without being compressed to a thickness at which its specific heat resistance assumes a value which is less than 5 m·K/W. If the specific heat resistance of the first insulation body has a value which is greater than or equal to 5 m·K/W, it can delay or even prevent spreading of the thermal runaway from one cell abutting thereon to the other cell abutting thereon.

In one preferred embodiment, the specific compression value corresponds to a compressed thickness of the first insulation body along the compression direction which is at least 0.3 mm.

The specific heat resistance of the first insulation body thus assumes a value which, even with aged cells, delays or even prevents spreading of the thermal runaway from one cell abutting thereon to the other cell abutting thereon.

One preferred embodiment further includes a second insulation body for thermal insulation of the two cells, which is arranged in the intermediate space and is configured to absorb a pressure exerted by the lateral surfaces of the two cells on lateral surfaces of the second insulation body respectively opposite thereto, where the compression is along the compression direction. The second insulation body comprises a thermally insulating and compressible material and has a rigidity as a function of the compression, where a value curve of the rigidity includes a third compression value section and a following fourth compression value section adjoining thereon. A slope of the rigidity as a function of the compression in the fourth compression value section is always higher than a maximum slope of the rigidity as a function of the compression in the third compression value section, The rigidity at a specific compression value within the fourth compression value section has a value at least two times higher than a maximum rigidity in the third compression value section. The specific compression value within the fourth compression value section corresponds to a thickness of the second insulation body along the compression direction at which the insulation body along the compression direction has a specific heat resistance of at least 5 m·K/W. The rigidity of the second insulation body in the third compression value section is always greater than the maximum rigidity of the first insulation body in the first compression value section. The second thermally insulating and compressible material can be a fiber material (for example ceramic or glass fibers) or an acrylate foam.

The rigidity in the spatial areas of the intermediate space which are each filled by the first insulation body and the second insulation body can thus be selected differently. In particular, the rigidity of the first insulation body and/or the rigidity of the second insulation body can be adapted to the distribution of the pressure which is applied to the cells for fixing the cell assembly and is absorbed by at least one of the two insulation bodies. For example, the pressure applied for fixing and absorbed by the first insulation body can be greater in outer edge areas than in the middle spatial area.

In one preferred embodiment, the second insulation body encloses at least one surface section of the first insulation body, at least in sections, which is not opposite to a lateral surface of one of the two cells.

The rigidity in the outer spatial area of the intermediate space and the rigidity in the middle spatial area of the intermediate space can thus be selected differently. In particular, the rigidity of the first insulation body and/or the rigidity of the second insulation body can be adapted to the distribution of the pressure which the bulging cells apply on the insulation body. For example, a lower rigidity is desirable in the middle spatial area of the intermediate space, where the bulging of the cells is stronger, than in the outer spatial areas, where the bulging of the cells is not as strong.

One preferred embodiment further includes a third insulation body for thermal insulation of the two cells, which is arranged in the intermediate space and is configured to absorb a pressure exerted by the lateral surfaces of the two cells on lateral surfaces of the third insulation body respectively opposite thereto, where the compression is along the compression direction. The third insulation body includes a third thermally insulating and compressible material and has a rigidity as a function of the compression, where a value curve of the rigidity has a fifth compression value section and a following sixth compression value section adjoining thereon. A slope of the rigidity as a function of the compression in the sixth compression value section is always higher than a maximum slope of the rigidity as a function of the compression in the fifth compression value section. The rigidity at a specific compression value within the sixth compression value section has a value at least twice as high as a maximum rigidity in the fifth compression value section. The specific compression value within the sixth compression value section corresponds to a thickness of the second insulation body along the compression direction at which the insulation body has a specific heat resistance of at least 5 m·K/W along the compression direction. The rigidity of the third insulation body in the fifth compression value section is always greater than the maximum rigidity of the first insulation body in the first compression value section. The second insulation body, the first insulation body, and the third insulation body, in this sequence, are arranged in the form of a stack on one another along a parallel to at least one of the lateral surfaces of the two cells delimiting the intermediate space. The third thermally insulating and compressible material can be a fiber material (for example ceramic or glass fibers) or an acrylate foam.

The rigidity in the spatial areas of the intermediate space which are respectively filled by the first insulation body, the second insulation body, and the third insulation body can thus be selected differently. In particular, the rigidity of the first insulation body and/or the rigidity of the second insulation body and/or the rigidity of the third insulation body can be adapted to the distribution of the pressure which is applied to the insulation body for fixing the cell assembly and/or due to the bulging of the cells.

The first insulation body, the second insulation body, and the third insulation body can differ, for example, in the type of the fiber material which they each include. The first, second, and third fiber material can differ in at least one of the following: the type of the fibers which they each include, the area weight of the fibers. By matching selection of the fibers and/or their area weight, the specific heat resistance of an insulation body and/or its rigidity characteristic curve may be adjusted to different cell formats.

The rigidity of the third insulation body can at least in sections have the same dependence on the compression value as the rigidity of the second insulation body.

In one preferred embodiment, the second insulation body and the third insulation body are identically formed.

The adaptation of the rigidity of the first, the second, and the third insulation body to a distribution of the pressure symmetrical with respect to the first insulation body can thus take place efficiently.

In one preferred embodiment, the specific compression value within the fourth compression value section corresponds to a pressure on the opposing lateral surfaces of the second insulation body along the compression direction of at least 1 MPa; and/or

the specific compression value within the sixth compression value section corresponds to a pressure on the opposing lateral surfaces of the third insulation body along the compression direction of at least 1 MPa.

The second insulation body and/or the third insulation body can thus absorb both the pressure required for fixing the cell assembly and the pressure which arises due to the bulging of the cells at advanced age of the cells, without being compressed to a thickness at which its or their specific heat resistance assumes a value which is less than 5 m·K/W. If the specific heat resistance of the second insulation body has a value which is greater than or equal to 5 m·K/W it can then delay or prevent spreading of the thermal runaway from one cell abutting thereon to the other cell abutting thereon. The same is true of the third insulation body.

In one preferred embodiment, the first insulation body is elastically deformable along the compression direction over the entire first compression value section.

The pressure which is exerted on the cells for fixing or connecting the cells can thus be absorbed by the first insulation body.

In one preferred embodiment, the second insulation body is elastically deformable along the compression direction over the entire third compression value section; or

the third insulation body is elastically deformable along the compression direction over the entire fifth compression value section.

The pressure which is exerted on the cells for fixing or connecting the cells can thus also be absorbed by the second insulation body or by the second and third insulation bodies.

In one preferred embodiment, at least the first insulation body includes a first thermally insulating filler which is located in intermediate spaces lying between the fibers of the first fiber material.

The specific resistance of the first insulation body and/or its rigidity characteristic curve can thus be adjusted to various cell formats.

The filler can inhibit thermal propagation like an aerogel, for example. If the second insulation body includes a fiber material as the second thermally insulating and compressible material, this can also include a thermally insulating filler inhibiting thermal propagation, which is located in intermediate spaces lying between the fibers of this fiber material. The third insulation body, if it includes a fiber material as the third thermally insulating and compressible material, can also include a thermally insulating third filler inhibiting thermal propagation, which is located in intermediate spaces lying between the fibers of this fiber material. The first, second, and third fillers can be different. By matching selection of the fiber material, its area weight, and the filler, the specific heat resistance of an insulation body and/or its rigidity characteristic curve may be adjusted to different cell formats.

One preferred embodiment furthermore includes an insulation film arranged at least in sections between the two cells for the electrical insulation of the two cells.

The two cells can thus also be electrically insulated from one another. The insulation body or bodies can be adhesively connected to the insulation film, for example by adhesive bonding.

In one preferred embodiment, the insulation film encloses the insulation body or bodies arranged between the two cells on all sides with the exception of one or more ventilation holes provided in the insulation film.

The electrical insulation between the two cells can thus be further improved. Soiling of the manufacturing environment and the high-voltage storage device in which the cell assembly is used, due to escape of fiber material or filler, can also be avoided. Furthermore, upon the compression of the insulation body or bodies caused by the bulging of the cells, the air can escape from the insulation film and flow back in again when the bulging of the cells recedes. Overall, the service life of the cells and of the high-voltage storage device in which they are used is thus lengthened.

A second aspect of the present invention relates to a cell module, including a cell assembly according to this disclosure, in which the individual cells are fixed relative to one another.

A cell module may thus be provided in which the heat conduction between adjacent cells, even at advanced age of the cells, is reduced enough that a thermal runaway is delayed or prevented.

A third aspect of the present invention relates to a high-voltage storage device, including a plurality of cell modules including at least one cell module according to this disclosure.

The level of safety of a high-voltage storage device may thus be increased.

Further advantages, features, and possible applications of the present invention result from the following detailed description in conjunction with the figures.

### BRIEF DESCRIPTION OF THE FIGURES

In the figures

FIG. 1 schematically shows the structure of a cell module;

FIG. 2a schematically shows the structure of a cell module according to a first embodiment;

FIG. 2b schematically shows the arrangement of two adjacent cells in a cell module according to the first embodiment;

FIG. 3a schematically shows the arrangement of two adjacent cells in a cell module according to a second embodiment;

FIG. 3b schematically shows a section along plane A-A;

FIG. 3c schematically shows a section along plane B-B;

FIG. 4a schematically shows the arrangement of two adjacent cells in a cell module according to a third embodiment;

FIG. 4b schematically shows a section along plane C-C;

FIG. 4c schematically shows a section along plane D-D;

FIG. 5a schematically shows the value curve of the specific heat resistance of an insulation body as a function of its compression;

FIG. 5b schematically shows the value curve of the rigidity of an insulation body as a function of the compression; and

FIG. 5c schematically shows the value curve of the pressure acting on the lateral surfaces of an insulation body as a function of the compression.

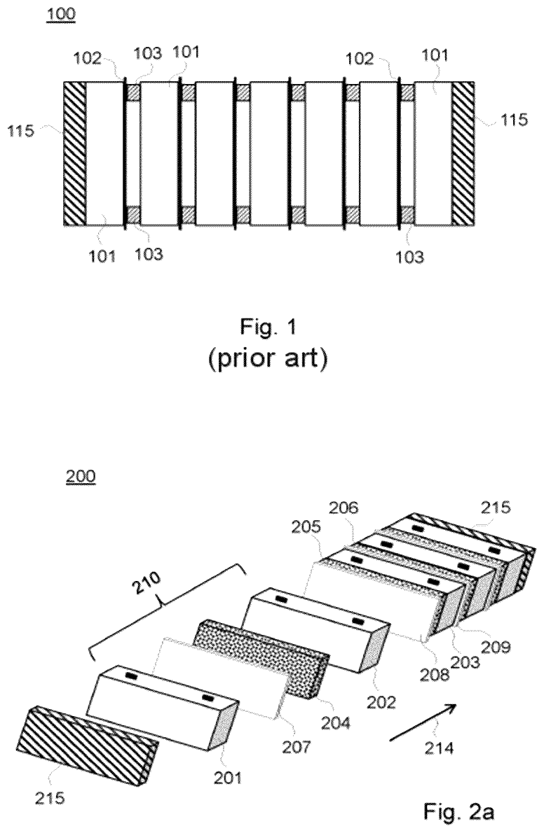

Throughout the figures, identical reference signs are used for identical or corresponding elements.

### DETAILED DESCRIPTION OF THE FIGURES

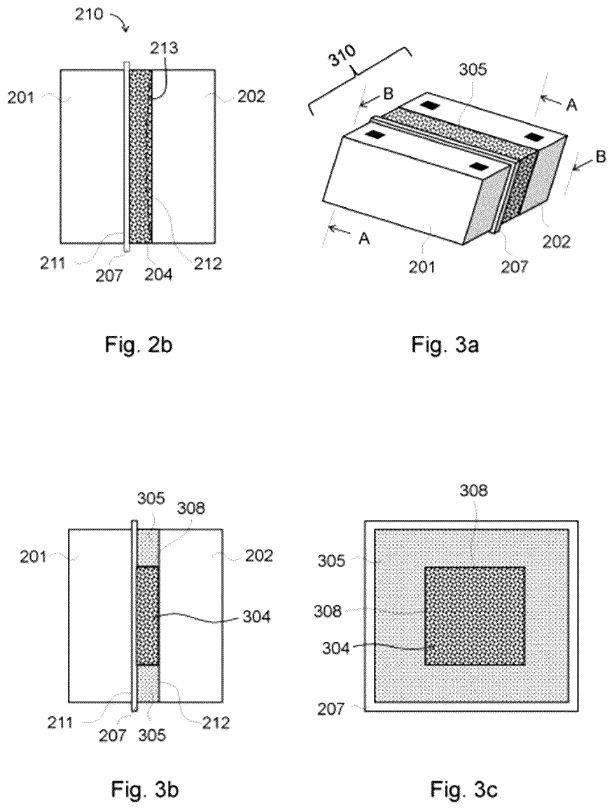

FIG. 2a shows a perspective view, partially in an exploded illustration, of a cell module according to a first embodiment. The cell module 200 can be provided for a high-voltage storage device for storing electrical energy. It includes: two or more cells for electrochemically storing electrical energy, 201, 202, 203; one or more insulation films 207, 208, 209; and one or more insulation bodies 204, 205, 206. One insulation film and one insulation body are arranged in each case between two adjacent cells. The cells can be lithium cells or lithium-ion cells.

The insulation films 207, 208, 209 are designed for electrical insulation of two adjacent cells and can each be a PET plastic film. The insulation films can contain mica.

The insulation bodies 204, 205, 206 are designed for thermal insulation of two adjacent cells and each include a first thermally insulating and compressible fiber material. A filler or aerogel can be located in the intermediate spaces lying between fibers of the first fiber material.

During the production of the cell module 200 shown in FIG. 2a, the cells, the insulation films, and the insulation bodies are arranged along an assembly direction 214, thus in a series so that in each case one insulation film and one insulation body are located in an intermediate space, which is delimited by one lateral surface of each of two adjacent cells. The two ends of the series are each provided with a pressure plate 215, which compresses the series thus formed to a specified length, and the series of cells compressed to the specified length is provided with a frame which holds together (fixes) the cells. Upon the compression, tolerance variations of the cells can be compensated for by compressing the insulation bodies.

The arrangement of the cells in the cell module 200 extends along one dimension (series). However, this disclosure also covers arrangement of cells which extend along two or three dimensions. In such an arrangement, one cell can be enclosed by multiple insulation bodies.

In the cell module 200, the cell assembly designated by the reference sign 210 is always identical. Therefore, it will also be explained in more detail as a representative of the other adjacent cells in the cell module.

The cell assembly 200 is schematically shown in FIG. 2b and contains: the two adjacent cells for electrochemically storing electrical energy, 201 and 202; the insulation film 207 for electrical insulation of the two cells; and the insulation body 204; wherein the insulation film 207 and the insulation body 204 are arranged in the intermediate space delimited by one lateral surface of each of the two cells.

The reference signs 211 and 212 designate the lateral surfaces of the two cells 201 and 202 which delimit the intermediate space between these cells. The lateral surfaces 211 and 212 are preferably perpendicular to the assembly direction 214. The insulation film 207 can be arranged adhering to the lateral surface 211 of the cell 201 and can completely cover it. The insulation body 204 can be arranged between the insulation film 207 and the lateral surface 212 of the cell 202. It may fill the entire space between the insulation film 207 and the lateral surface 212. In addition, the insulation body 204 can be adhesively bonded to the insulation film 207.

Due to the compressing and fixing of the cells during the production of a cell module, the lateral surfaces 211 and 212 forming the intermediate space exert a pressure on the lateral surfaces of the insulation body 204 opposite to each of them, which results in a compression of the insulation body 204 along the assembly direction 214. For example, an insulation body which has an initial thickness of 2-3 mm before the compressing and fixing of the cells may be compressed by the compressing and fixing of the cells to a thickness of 0.8-1.1 mm, which essentially also corresponds to the distance between the two lateral surfaces 211 and 212, because the insulation film 207 can be selected to be very thin.

In addition to the pressure with which the cells of the cell module are fixed, the lateral surfaces 211 and 212 can also exert a pressure on the insulation body 204 which is caused by the bulging of the cells. As a result of this pressure, a further compression of the insulation body 204 can occur along the assembly direction 214. Because the bulging increases with progressing age of the cells, the compression of the insulation body 204 also increases with time. The pressure which is exerted by the sides 211 and 212 on the insulation body 204 can reach up to 1 MPa (megapascal). The bulging 213 of the lateral surface 212 is shown by way of example in FIG. 2b.

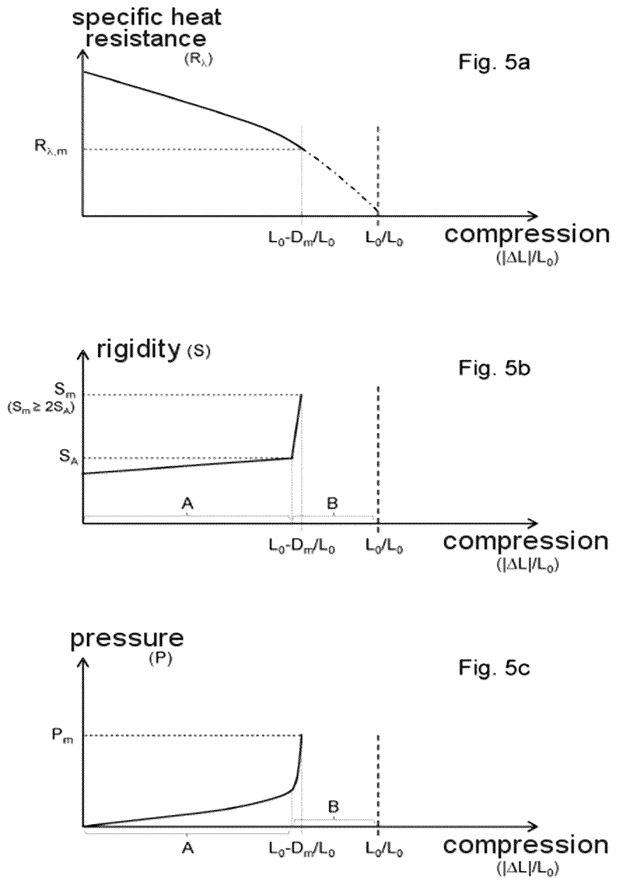

The value curve of the specific heat resistance R_{λ} of the insulation body 204 is schematically shown as a function of the compression |ΔL|/L₀ in FIG. 5a, wherein L₀ is the length of the insulation body 204 in the uncompressed state and ΔL is its length change in the compression direction due to the compression. The figure shows that the specific heat resistance of the insulation body 204 decreases with increasing compression, and can fall below a value R_{λ,m} from a specific first compression value (L₀−Dₘ)/L₀. If the specific heat resistance of the insulation body 204 falls below the value R_{λ,m}, the insulation body 204 can no longer adequately delay a thermal runaway from the cell 201 to the cell 202 or vice versa, and a thermal runaway of the entire cell module can occur.

Dₘ is the thickness of the (compressed) insulation body 204 along the compression direction, at which it assumes the specific heat resistance R_{λ,m} along the compression direction. In order that the insulation body 204 can adequately delay spreading of a thermal runaway from the cell 201 to the cell 202 or vice versa, its specific heat resistance R_{λ,m} has to have at least the value 5 m·K/W. The minimum thickness Dₘ which an insulation body 204 which includes, for example, ceramic or glass fibers as a fiber material must have, so as not to fall below R_{λ,m}=5 m·K/W, is 0.3 mm.

To avoid the compression of the insulation body 204 to compression values which are greater than the specific first compression value (L₀−Dₘ)/L₀, the insulation body 204 is configured so that, with respect to the pressure which the lateral surfaces 211 and 212 exert on the lateral surfaces of the insulation body 204 respectively opposite thereto, it has a rigidity S, the value curve of which as a function of the compression |ΔL|/L₀ has a first compression value section A and a second compression value section B adjoining the first compression value section, wherein i) the slope of the rigidity in the second compression value section is always higher than the maximum slope of the rigidity in the first compression value section, ii) the rigidity Sm with respect to the specific first compression value (L₀−Dₘ)/L₀ within the second compression value section has a value at least twice as high as the maximum rigidity SA in the first compression value section, and iii) the specific first compression value corresponds to a thickness Dₘ of the insulation body 204 at which the insulation body 204 has a specific heat resistance along the compression direction of at least R_{λ,m}=5 m·K/W. The rigidity characteristic curve of the insulation body 204 as a function of the compression is schematically shown in FIG. 5b.

In FIG. 5b, the slope of the rigidity in the rigidity value sections A and B is linear. However, this is only by way of example. The slope of the rigidity in each of the rigidity value sections A on B can also be nonlinear. In the second rigidity value section B, the slope of the rigidity is always positive at least up to the specific first compression value (L₀−Dₘ)/L₀. In the first rigidity value section A, the slope of the rigidity can be positive, zero, or zero at least in sections.

The insulation body 204 is preferably elastically deformable along the compression direction, in particular over the first compression value section.

The rigidity of the insulation body 204 in the first rigidity value section A is advantageously sufficiently large that it compensates for the pressure which is required for fixing the cells and the pressure which is generated by the bulging of the cells during charging/discharging cycles at a compression |ΔL|/L₀ which is in the first rigidity value section A. A compression of the insulation body 204 into the second rigidity value section B, but at most up to the specific first compression value (L₀−Dₘ)/L₀, can take place, above all at advanced age of the cells. This is because in addition to the bulging during charging/discharging cycles, lasting bulging, which grows over time, of the cells is also added. The spreading of thermal runaway between the cells 201 and 202 can thus be sufficiently delayed even at advanced age of the cells.

The first rigidity value section is preferably longer than the part of the second rigidity value section which lies before the specific first compression value. The insulation body 204 can thus absorb the bulging of the cells 201 and 202 along the assembly direction without restricting it too much.

The pressure P which the lateral surfaces 211 and 212 exert on the lateral surfaces of the insulation body 204 respectively opposite thereto, as a function of the compression |ΔL|/L₀, is schematically shown in FIG. 5c. It shows that the pressure exerted on the insulation body 204 rises more steeply in the part of the second rigidity value section which lies before the specific first compression value (L₀−Dₘ)/L₀ than in the first rigidity value section.

The pressure which the lateral surfaces 211 and 212 exert on the lateral surfaces of the insulation body 204 respectively opposite thereto can reach 1 MPa. Therefore, the specific first compression value (L₀−Dₘ)/L₀ preferably corresponds to a pressure on the opposing sides of the insulation body 204 of at least Pₘ=1 MPa.

Dₘ can on the one hand be viewed as the thickness of the insulation body 204 at which it cannot be compressed further by the two lateral surfaces 211 and 212 and on the other hand as the thickness at which the insulation body 204 does not fall below the specific heat resistance of 5 m·K/W. Dₘ is also referred to as the blocking length of the insulation body 204.

The specific first compression value (L₀−Dₘ)/L₀ preferably corresponds to a compressed thickness of the insulation body 204 which is at least Dₘ=0.3 mm. This may advantageously be achieved using an insulation body 204 which includes ceramic or glass fibers as the fiber material.

A first variant of a cell module according to the first embodiment (which is not shown in the figures) differs from the cell module 200 shown in FIG. 2a in that it includes two insulation films for electrically insulating two adjacent cells, wherein one of the two insulation films is arranged between one of the adjacent cells and the insulation body and the other of the two insulation films is arranged between the other of the adjacent cells and the insulation body.

A second variant of a cell module according to the first embodiment (which is not shown in the figures) differs from the cell module 200 shown in FIG. 2a in that it includes an insulation film for electrically insulating two adjacent cells, which encloses the insulation body on all sides with the exception of one or more ventilation holes provided in the insulation film.

A cell module according to a second embodiment differs from the cell module according to the first embodiment in the implementation of the thermal insulation between two adjacent cells. In the cell module according to the second embodiment, two adjacent cells are arranged according to the cell assembly 310 schematically shown in FIG. 3a. FIG. 3b shows a section through plane A-A and FIG. 3c shows a section through plane B-B. Plane A-A is parallel to the assembly direction of the two cells 201 and 202 and goes through the middle of the cell assembly 310. Plane B-B is perpendicular to the assembly direction of the two cells 201 and 202 and lies between the insulation film 207 and the cell 202.

The cell assembly 310 differs from the cell assembly 210 in that it includes two insulation bodies 304 and 305, which are arranged in the intermediate space delimited by the lateral surfaces 211 and 212. Both insulation bodies include lateral surfaces which are opposite to the lateral surfaces 211 and 212. The lateral surfaces 308 of the insulation body 304 which are not opposite to the lateral surfaces 211 and 212 are enclosed by the insulation body 305 in an abutting manner. The insulation body 305 and the insulation body 304 may fill the entire intermediate space between the insulation film 207 and the lateral surface 212.

The insulation body 305 can include a different thermally insulating and compressible material, for example an acrylate foam, in place of a thermally insulating and compressible fiber material.

The insulation bodies 304 and 305 are shown as rectangles by way of example in FIGS. 3b and 3c. However, the insulation bodies 304 and 305 can also assume other geometric shapes. It is important that each includes two lateral surfaces, of which one each is opposite to one of the lateral surfaces 211 and 212, and at least one surface section 308 of the insulation body 304 is enclosed by the insulation body 305 in an abutting manner.

The insulation body 304 differs from the insulation body 204 of the first embodiment in that it only fills one area of the space (the middle one) between the insulation film 207 and the lateral surface 212. Otherwise, the statements made for the insulation body 204 also apply analogously to the insulation body 304.

Due to the compressing and fixing of the cells during the production of a cell module according to the second embodiment, the lateral surfaces 211 and 212 forming the intermediate space exert a pressure on the lateral surfaces of the insulation bodies 304 and 305 respectively opposite thereto which results in a compression of the insulation bodies along the assembly direction 214. In addition to the pressure with which the cells of the cell module are fixed, the lateral surfaces 211 and 212 can also exert a pressure on the insulation bodies 304 and 305, which is caused by the bulging of the cells. A further compression of the insulation bodies along the assembly direction 214 can occur as a result of this pressure. The bulging can increase with progressing age of the cells. The pressure which is exerted by the sides 211 and 212 on the insulation bodies 304 and 305 can reach up to 1 MPa.

The value curve of the specific heat resistance of the insulation body 305 as a function of the compression is analogous to that shown in FIG. 5a. The specific heat resistance of the insulation body 305 decreases with increasing compression and can fall below the value 5 m·K/W from a specific second compression value, which the insulation body 305 has to have to sufficiently delay spreading of a thermal runaway from the cell 201 to the cell 202 or vice versa.

To avoid the compression of the insulation body 305 to compression values which are greater than the specific second compression value, the insulation body 305 is configured so that, with respect to the pressure which the lateral surfaces 211 and 212 exert on the lateral surfaces of the insulation body 305 respectively opposite thereto, it has a rigidity, the value curve of which as a function of the compression has a third compression value section and a fourth compression value section adjoining the third compression value section, wherein i) the slope of the rigidity in the fourth compression section is always higher than the maximum slope of the rigidity in the third compression section, ii) the rigidity with respect to the second compression value within the fourth compression value section has a value at least twice as high as the maximum rigidity in the third compression value section, and iii) this specific second compression value corresponds to a thickness of the insulation body 305 at which the insulation body 305 has a specific heat resistance of at least 5 m·K/W along the compression direction. The rigidity characteristic curve of the insulation body 305 is analogous to that shown in FIG. 5b.

The insulation body 305 is preferably elastically deformable along the compression direction, in particular over the third compression value section.

The rigidity of the insulation body 305 in the third rigidity value section is advantageously sufficiently large that it compensates for the pressure which is required for fixing the cells and the pressure which is generated by the bulging of the cells during charging/discharging cycles at a compression which is in the third rigidity value section. A compression of the insulation body 305 into the fourth rigidity value section, but at most up to the specific second compression value section, can take place, above all at advanced age of the cells. The spreading of thermal runaway between the cells 201 and 202 can thus be sufficiently delayed even at advanced age of the cells.

The third rigidity value section is preferably longer than the part of the fourth rigidity value section which lies before the specific second compression value. The insulation body 305 can thus absorb the bulging of the cells 201 and 202, without restricting it too much.

Because the cells 201 and 202 bulge less strongly into the outer spatial areas of the intermediate space delimited by the lateral surfaces 211 and 212 than into the middle spatial area of the intermediate space, the rigidity of the insulation body 305 in the third compression value section is always greater than the maximum rigidity of the insulation body 304 in the first compression value section. The length of the first compression value section and the length of the third compression value section can be equal or different.

The value curve of the pressure which the lateral surfaces 211 and 212 exert on the lateral surfaces of the insulation body 305 respectively opposite thereto as a function of the compression is analogous to that shown in FIG. 5c.

The pressure which the lateral surfaces 211 and 212 exert on the lateral surfaces of the insulation bodies 304 and 305 respectively opposite thereto can reach 1 MPa. Therefore, the specific second compression value preferably corresponds to a pressure on the opposite sides of the insulation body 305 of at least 1 MPa.

The thickness of the insulation body 305 corresponding to the specific second compression value can be viewed as the thickness of the insulation body 305 at which it cannot be compressed further by the two lateral surfaces 211 and 212. Furthermore, it is the thickness at which the insulation body 305 does not fall below the specific heat resistance of 5 m·K/W.

The specific second compression value preferably corresponds to a compressed thickness of the insulation body 305 which is at least 0.3 mm. This may advantageously be achieved using an insulation body 305 which includes ceramic or glass fibers as the fiber material.

The cell assembly shown in FIG. 3a can include two insulation films for electrically insulating the two cells 201 and 202. One insulation film is arranged here between the cell 201 and the insulation bodies 304 and 305, and the other insulation film is arranged between the two insulation bodies and the cell 202.

The cell assembly shown in FIG. 3a can include, instead of the insulation film 207, an insulation film for electrically insulating the two cells 201 and 202 which encloses the two insulation bodies 304 and 305 on all sides with the exception of one or more ventilation holes provided in the insulation film.

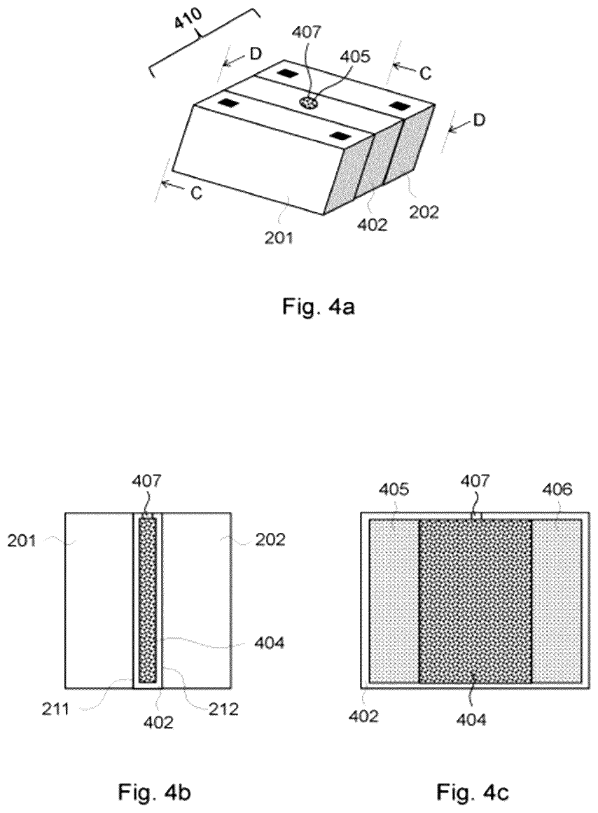

A cell module according to a third embodiment differs from the cell module according to the first and second embodiment in the implementation of the thermal and electrical insulation between two adjacent cells. In the cell module according to the third embodiment, two adjacent cells are arranged according to the cell assembly 410 schematically shown in FIG. 4a. FIG. 4b shows a section through plane C-C and FIG. 4c shows a section through plane D-D. Plane C-C is parallel to the assembly direction of the two cells 201 and 202 and goes through the middle of the cell assembly 410. Plane D-D is perpendicular to the assembly direction and goes through the middle of the insulation bodies enveloped using the insulation film 402.

The cell assembly 410 differs from the cell assembly 310 in that it includes three insulation bodies 404, 405, and 406, which are arranged in the intermediate space delimited by the lateral surfaces 211 and 212; and in that the insulation film 402 for electrically insulating the cells 201 and 202 encloses the three insulation bodies with the exception of one or more ventilation holes provided in the insulation film. All three insulation bodies include lateral surfaces which are opposite to the lateral surfaces 211 and 212. As FIG. 4c shows, the insulation bodies 404, 405, and 406, in this sequence, are arranged adjacent to one another (or stacked) along and in parallel to at least one of the lateral surfaces 211 and 212. The three insulation bodies can have the shape of a cuboid and they fill the entire intermediate space between the lateral surfaces 211 and 212. The opposing lateral surfaces of the insulation bodies are abutting.

The insulation bodies 405 and/or 406 can each include, instead of a thermally insulating and compressible fiber material, another thermally insulating and compressible material, for example an acrylate foam.

The insulation bodies 404 and 405 differ from the insulation bodies 304 and 305 of the second embodiment in their shape and arrangement in relation to one another. Otherwise, the statements made for the insulation body 204 also apply to the insulation body 404 and the statements made for the insulation body 305 also apply to the insulation body 405.

The insulation body 405 and the insulation body 406 are advantageously formed identically and/or arranged symmetrically with respect to the insulation body 404.

If the insulation body 405 and the insulation body 406 are formed differently, the insulation body 406 then has a specific heat resistance the value curve of which as a function of the compression is analogous to that shown in FIG. 5a.

Furthermore, the insulation body 406 is configured so that, with respect to the pressure which the lateral surfaces 211 and 212 exert on the lateral surfaces of the insulation body 406 respectively opposite thereto, it has a rigidity, the value curve of which as a function of the compression includes a fifth compression value section and a sixth compression value section adjoining the fifth compression value section, wherein i) the slope of the rigidity in the sixth compression value section is always higher than the maximum slope of the rigidity in the fifth compression value section, ii) the rigidity at a specific third compression value within the sixth compression value section has a value at least twice as high as the maximum rigidity in the fifth compression value section, and iii) this specific third compression value corresponds to a thickness of the insulation body 406 at which the insulation body 406 has a specific heat resistance of at least 5 m·K/W along the compression direction. The rigidity characteristic curve of the insulation body 406 is analogous to that shown in FIG. 5b.

The insulation body 406 is preferably elastically deformable along the compression direction, in particular over the third compression value section.

The rigidity of the insulation body 406 in the fifth rigidity value section is advantageously sufficiently large that it compensates for the pressure which is necessary for fixing the cells and the pressure which is generated by the bulging of the cells during charging/discharging cycles at a compression which is in the fifth rigidity value section. A compression of the insulation body 406 into the sixth rigidity value section, but at most up to the specific third compression value, can take place, above all at advanced age of the cells.

The fifth rigidity value section is preferably longer than the part of the sixth rigidity value section which lies before the specific third compression value.

The rigidity of the insulation body 406 in the fifth compression value section is preferably always greater than the maximum rigidity of the insulation body 404 in the first compression value section. The length of the first compression value section and the length of the fifth compression value section can be equal or different. Furthermore, the length of the third compression value section and the length of the fifth compression value section can be equal or different.

The value curve of the pressure which the lateral surfaces 211 and 212 exert on the lateral surfaces of the insulation body 406 respectively opposite thereto as a function of the compression is analogous to that shown in FIG. 5c.

The specific third compression value preferably also corresponds to a pressure on the opposing sides of the insulation body 305 of at least 1 MPa.

The specific third compression value preferably corresponds to a compressed thickness of the insulation body 406 which is at least 0.3 mm. This may be achieved using an insulation body 406 which includes ceramic or glass fibers as a fiber material.

The insulation film 402 advantageously includes a ventilation hole 407 on a lateral surface which is not opposite to one of the lateral surfaces 211 and 212. Upon the compression of the insulation bodies caused by the bulging of the cells, the air can escape through the ventilation hole 407 from the insulation envelope and flow back in again when the bulging of the cells recedes. Bursting of the insulation film 402 and thus an escape of fiber material or filler to the outside are thus prevented.

Due to its compressibility, the insulation body or bodies can compensate for tolerance variations of the cells during the production of a cell module according to the invention, so that even if the cells have different thicknesses in the assembly direction 214, the cell module can be compressed to the predetermined length.

While at least one exemplary embodiment has been described above, it is to be noted that a large number of variations thereto exists. It is also to be noted that the described exemplary embodiments only represent nonlimiting examples, and it is not intended that the scope, the applicability, or the configuration of the devices and methods described here are thus restricted. Rather, the preceding description will give a person skilled in the art an instruction for implementing at least one exemplary embodiment, wherein it is apparent that various changes can be performed in the functionality and the arrangement of the elements described in an exemplary embodiment without deviating from the subject matter defined in each of the appended claims and the legal equivalents of that subject matter.

### LIST OF REFERENCE NUMERALS

100 cell module
101 cell for storing electrical energy
102 plastic film
103 spacer
115 pressure plate
200 cell module according to the invention
201, 202, 203 cell for storing electrical energy
204, 205, 206 first insulation body
207, 208, 209 insulation film
210 cell assembly according to the invention
211, 212 lateral surface of a cell
213 bulge of the cell
214 assembly direction of the cells in a cell module
215 pressure plate
304 first insulation body
305 second insulation body
308 surface section of a first insulation body
310 cell assembly according to the invention
404 first insulation body
402 insulation film
405 second insulation body
406 third insulation body
407 ventilation hole
410 cell assembly according to the invention

1-15. (canceled)

16. A cell assembly for an electrochemical energy storage device, the cell assembly including:
two cells for electrochemically storing electrical energy; and
a first insulation body for thermally insulating the two cells from one another, the first insulation body being arranged in an intermediate space between the cells delimited by one lateral surface of each of the two cells and being configured to absorb a pressure exerted by the lateral surfaces of the two cells on lateral surfaces of the first insulation body respectively opposite thereto, a compression being along a compression direction, the first insulation body comprising:
a first thermally insulating and compressible fiber material; and
a rigidity as a function of the compression having a value curve including a first compression value section and a second compression value section adjoining the first compression value section,
wherein
a slope of the rigidity as a function of the compression in the second compression value section is higher than a maximum slope of the rigidity as a function of the compression in the first compression value section,
the rigidity at a specific compression value within the second compression value section has a value at least two times as high as a maximum rigidity in the first compression value section, and
the specific compression value corresponds to a thickness of the first insulation body along the compression direction at which the insulation body has a specific heat resistance of at least 5 m·K/W along the compression direction.

17. The cell assembly according to claim 16, wherein
the specific compression value corresponds to a pressure on the opposing lateral surfaces of the first insulation body along the compression direction of at least 1 MPa.

18. The cell assembly according to claim 17, wherein
the specific compression value corresponds to a compressed thickness of the first insulation body along the compression direction of at least 0.3 mm.

19. The cell assembly according to claim 16, further comprising:
a second insulation body for thermally insulating the two cells, the second insulation body also being arranged in the intermediate space and being configured to absorb the pressure exerted by the lateral surface of the two cells on lateral surfaces of the second insulation body respectively opposite thereto, the compression being along the compression direction, the second insulation body including:
a second thermally insulating and compressible material; and
a rigidity as a function of the compression having a value curve including a third compression value section and a fourth compression value section adjoining thereon,
wherein
a slope of the rigidity as a function of the compression in the fourth compression value section is higher than a maximum slope of the rigidity as a function of the compression in the third compression value section,
the rigidity at a specific compression value within the fourth compression value section has a value at least two times higher than a maximum rigidity in the third compression value section,
the compression value within the fourth compression value section corresponds to a thickness of the second insulation body along the compression direction at which the insulation body along the compression direction has a specific heat resistance of at least 5 m·K/W, and the rigidity of the second insulation body in the third compression value section is greater than the maximum rigidity of the first insulation body in the first compression value section.

20. The cell assembly according to claim 19, wherein
the second insulation body encloses at least one surface section of the first insulation body, at least in sections, which is not opposite to the lateral surface of one of the two cells.

21. The cell assembly according to claim 19, further comprising:
a third insulation body for thermally insulating the two cells, the third insulation body also being arranged in the intermediate space and being configured to absorb the pressure exerted by the lateral surface of the two cells on lateral surfaces of the third insulation body respectively opposite thereto, the compression being along the compression direction, the third insulation body including:
a third thermally insulating and compressible material;
a rigidity as a function of the compression having a value curve including a fifth compression value section and a sixth compression value section adjoining thereon,
wherein
a slope of the rigidity as a function of the compression in the sixth compression value section is always higher than a maximum slope of the rigidity as a function of the compression in the fifth compression value section,
the rigidity at a specific compression value within the sixth compression value section has a value at least twice as high as a maximum rigidity in the fifth compression value section,
the specific compression value within the sixth compression value section corresponds to a thickness of the second insulation body along the compression direction at which the insulation body has a specific heat resistance of at least 5 m·K/W along the compression direction,
the rigidity of the third insulation body in the fifth compression value section is always greater than the maximum rigidity of the first insulation body in the first compression value section, and
the second insulation body, the first insulation body, and the third insulation body, in this sequence, are arranged in a form of a stack on one another along a direction parallel to at least one of the lateral surfaces of the two cells delimiting the intermediate space.

22. The cell assembly according to claim 21, wherein
the second insulation body and the third insulation body are formed identically.

23. The cell assembly according to claim 19, wherein
the specific compression value within the fourth compression value section corresponds to a pressure on the opposing lateral surfaces of the second insulation body along the compression direction of at least 1 MPa; or
the specific compression value within the sixth compression value section corresponds to a pressure on the opposing lateral surfaces of the third insulation body along the compression direction of at least 1 MPa.

24. The cell assembly according to claim 16, wherein
the first insulation body is elastically deformable along the compression direction over an entirety of the first compression value section.

25. The cell assembly according to claim 19, wherein
the second insulation body is elastically deformable along the compression direction over an entirety of the third compression value section; or
wherein the third insulation body is elastically deformable along the compression direction over an entirety of the fifth compression value section.

26. The cell assembly according to claim 16, wherein
at least the first insulation body includes a first thermally insulating filler located in interstices between fibers of the first fiber material.

27. The cell assembly according to claim 16, further comprising:
an insulation film arranged at least in sections between the two cells for electrical insulation of the two cells.

28. The cell assembly according to claim 27, wherein
the insulation film encloses the insulation body or bodies arranged between the two cells on all sides with an exception of one or more ventilation holes provided in the insulation film.

29. A cell module including a cell assembly according to claim 16, wherein
the individual cells are fixed relative to one another.

30. A high-voltage storage device comprising:
a plurality of cell modules including at least one cell module according to claim 29.
